(19) United States
(12) Patent Application Publication
(10) Pub. No.: US 2026/0086871 A1
(43) Pub. Date: Mar. 26, 2026

(54) SYSTEMS AND METHODS FOR WRITE DISTRIBUTION WITH A SCHEDULER

(71) Applicant: Dell Products L.P., Round Rock, TX (US)

(72) Inventors: Rong Yu, West Roxbury, MA (US); Lixin Pang, Needham, MA (US); Sean Hu, Westborough, MA (US)

(73) Assignee: Dell Products L.P., Round Rock, TX (US)

(21) Appl. No.: 18/890,906

(22) Filed: Sep. 20, 2024

(51) Int. Cl. G06F 9/50

(52) U.S. Cl. CPC G06F 9/505

(57) ABSTRACT

A front-end, device group-based system and method in a storage array is disclosed for using a per-node request scheduler to monitor real-time I/O request distributions and forward I/O requests to a selected middle layer candidate node based on the resources and statistics of the middle layer and back end nodes present in a storage array. A scheduler on each middle layer node may be responsible for distributing I/O requests for a specific set of front-end devices. The scheduler may detect a skew in I/O request distribution and adjust distribution accordingly.

### BACKGROUND

Storage array systems consist of distributed cluster nodes for performance, extensibility, redundancy and fault tolerance. Director nodes of such systems are grouped into different functions to handle specific tasks. For example, front-end nodes handle host input/output (I/O) requests from hosts, middle layer nodes are responsible for data optimization and distribution. Back-end nodes are responsible for writing data from cache to disk (e.g., destaging) or retrieving data from disk. I/O operations flow follows a layered path from front-end nodes to middle layer nodes and finally to back-end nodes.

In a cluster node environment, ensuring equality of different nodes (e.g. equilibrium) is crucial for maintaining balance and efficiency in a healthy and reliable system. Currently, distribution of I/O requests from front-end nodes is based on a variety of factors, including for example, extent grouping, cache slot primary-secondary affinity, and virtual-provisioning allocation. Such methods attempt to ensure that each middle layer node will receive approximately the same amount of I/O requests. However, a balanced distribution from the top level (e.g. front-end) does not always result in a balanced workload or an optimized performance at back-end nodes due to runtime environment, hardware and other complexities. For example, even a slight skew of I/O distributions at the middle layer and back-end causes significant delays and performance degradation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include assigning each of a plurality of front end nodes in a storage array to a device group. A first front end node may receive an input/output (I/O) request. The I/O request may be sent to a middle layer node associated with the device group. A per-node scheduler may select a destination node to process the request. The destination node may be selected according to one or more I/O statistics relating to the storage array. The I/O request may be transmitted to the destination node for destaging.

The method may include, alone or in combination, one or more of the following features. A destination node may be selected based on balancing storage array resources. The I/O statistics may be stored in a database accessible to all nodes of the storage array. The database may be copied to a global memory in communication with the middle layer. The middle layer may be configured to update the database periodically. The I/O statistics may include one or more of a pending I/O count, queue depth, back end response time, CPU utilization, and write pending level. Selecting a destination node may include using a weighted model. Selecting a destination node may include using a machine learning model.

According to another aspect, a system may include a memory and at least one processor that is operatively coupled to the memory. The at least one processor may be configured to perform the operations of assigning each of a plurality of front end nodes in a storage array to a device group and receiving at a first front end node an I/O request. The I/O request may be sent to a middle layer node associated with the device group. A per-node scheduler may select a destination node to process the request. The destination node may be selected according to one or more I/O statistics relating to the storage array. The I/O request may be transmitted to the destination node for destaging.

The system may include, alone or in combination, one or more of the following features. A destination node may be selected based on balancing storage array resources. The I/O statistics may be stored in a database accessible to all nodes of the storage array. The database may be copied to a global memory in communication with the middle layer. The middle layer may be configured to update the database periodically. The I/O statistics may include one or more of a pending I/O count, queue depth, back end response time, CPU utilization, and write pending level. Selecting a destination node may include using one of a weighted model and a machine learning model.

According to another aspect, a non-transitory computer-readable medium storing one or more processor-executable instructions, which when executed by at least one processor may cause the at least one processor to perform the operations of assigning each of a plurality of front end nodes in a storage array to a device group and receiving at a first front end node an I/O request. The I/O request may be sent to a middle layer node associated with the device group. A per-node scheduler may select a destination node to process the request. The destination node may be selected according to one or more I/O statistics relating to the storage array. The I/O request may be transmitted to the destination node for destaging.

The non-transitory computer-readable medium may include, alone or in combination, one or more of the following features. The I/O statistics may be stored in a database accessible to all nodes of the storage array. The middle layer may be configured to update the database periodically. The I/O statistics may include one or more of a pending I/O count, queue depth, back end response time, CPU utilization, and write pending level. Selecting a destination node may include using one of a weighted model and a machine learning model.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a storage system, according to one or more aspects of the present disclosure;

FIG. 2 is a diagram of an example of a storage processor, according to one or more aspects of the present disclosure;

FIG. 3 is a flow diagram of traditional input/output (I/O) load balancing;

FIG. 4 is a flow diagram of input/output (I/O) load balancing using a per node scheduler, according to one or more aspects of the present disclosure;

FIG. 5 is a flow diagram of a method of distributing I/O requests, according to one or more aspects of the present disclosure; and

FIG. 6 is a diagram of an example of a computing device, according to one or more aspects of the present disclosure.

### DETAILED DESCRIPTION

Aspects of the present disclosure provide a front-end, device group-based methodology using a per-node request scheduler to monitor real-time I/O request distributions and forward I/O requests to the best middle layer candidate node based on the resources and statistics of the middle layer and back end nodes present in a storage array. A scheduler on each middle layer node may be responsible for distributing I/O requests for a specific set of front-end devices. The scheduler may detect a skew in I/O request distribution and adjust distribution accordingly. According to one aspect, front-end group-based scheduling may ensure fairness in distribution handling. The systems, methods, concepts and techniques described herein may improve system-wide node equality, prevent I/O request distribution skews and improve overall system performance.

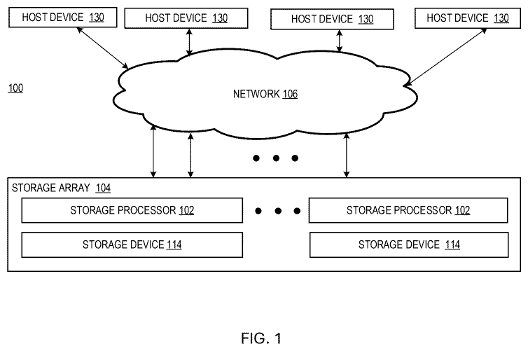

FIG. 1 is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax™, DELL PowerStore™, and/or any other suitable type of storage system. The storage array 104 may include or be arranged with one or more site-pairs and a plurality of non-volatile memory storage devices 114. Each site may be or include, as described herein, a virtual provider. Each site of the site pairs may include one or more storage processors 102. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

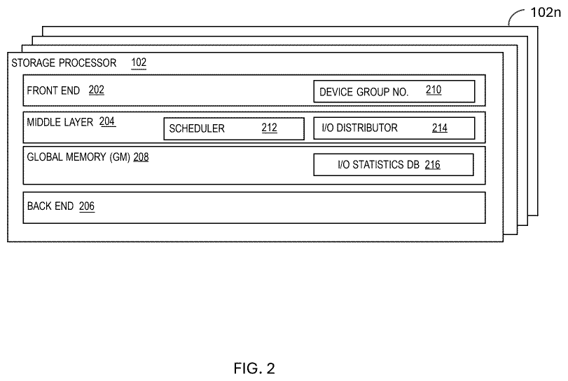

FIG. 2 is a diagram of an example of a storage processor 102, substantially similar to the storage processor 102 of FIG. 1, according to one or more aspects of the present disclosure. The storage processor 102 may be considered an engine, board, node, director or other collection of hardware, software and firmware. As discussed above, the storage processor 102 may be part of a node pair or node cluster in which multiple storage nodes, generally denoted as storage processors 102n work in conjunction as part of a storage array to process I/O requests execute the received I/O requests by reading and/or writing data to storage devices.

Each storage processor 102 may include a front end 202, a middle layer 204, and a back end 206. The storage processor may further include or be in communication with a global memory 208. While the global memory 208 of FIG. 2 is shown as part of the storage processor 102, one skilled in the art will recognize that the global memory 208 may be located outside of the storage processor 102 and may also be in communication with other storage processors (e.g., nodes, boards or engines) in the storage array. As described herein a copy of the global memory may also or instead be stored locally on the storage processor.

According to one aspect, the front end 202 may be configured to receive the I/O requests from the hosts. As described herein, the front end 202 may be configured to include a device group number 210. In doing so, as explained herein, the particular storage processor 102 may be configured as part of a device group to receive I/O requests of a certain type (e.g., related, sequential or extent-based). According to one aspect, front ends 202 may be assigned to a group according to a device number, such that all requests assigned to a particular device group will be managed by the same storage processor 102.

According to one aspect, requests received to a front end 202 in the device group may then be processed by the middle layer where a scheduler 212 may use an I/O distributor 214 to determine an optimal destination for the request. On each middle layer node of the cluster, the scheduler 212 and I/O distributor 214 may be responsible for monitoring workload and distributing the requests to the best middle layer nodes in the cluster for local synchronous write destage (LSWD) processing at the back end 206. Each storage processor 102 in the cluster may include its own scheduler 212 (e.g., a per-node scheduler) tasked with determining which storage processors 102, including its own, may be best suited for further handling the request.

The per-node scheduler 212 may be responsible for monitoring in real time I/O distributions and forwarding I/O requests to the best candidate node based on middle layer and back end resources and statistics. The scheduler 212 on each storage processor 102 node may be responsible for distributing I/O requests for a specific group of front end devices (e.g. the particular device group). This mechanism ensures I/O distribution skew may be detected and I/O distribution may be adjusted accordingly.

According to one aspect, the scheduler 212 and I/O distributor 214 may rely on global memory 208 and an I/O statistics database 216 to assist in determining the optimal destination (e.g., the best storage processor 102 in the cluster). The database 216 may include and maintain periodically updated statistics related to the operations of all storage processors 102 in the cluster, including for example, CPU processing times and loads, queue lengths, response times, or the like. In doing so, the scheduler 212 and I/O distributor 214 may improve system-wide node equality, prevent unhandled I/O distribution skews and improve overall system performance.

In contrast, traditional I/O processing where I/O request distributions are based on ensuring a similar quantity of requests across the nodes in cluster may not be truly balanced as not all I/O requests use the same amount of resources. While the number of requests may be spread evenly over the nodes, the computing and processing resources and response times may differ greatly, creating an imbalance in workload that can disrupt system performance.

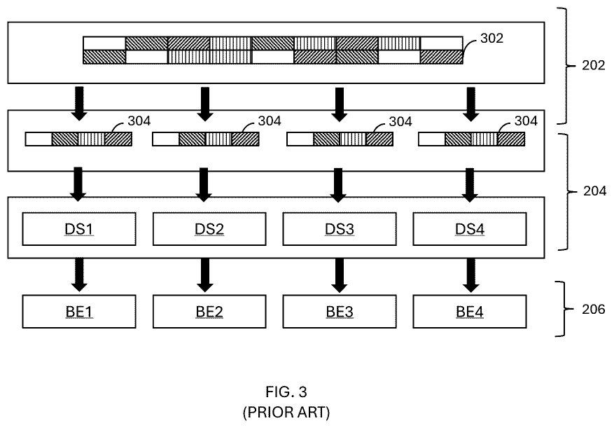

FIG. 3 is a flow diagram of a traditional I/O processing flow. The front end 202 may receive a number of I/O requests 302 for varying types, sizes, and devices. According to known techniques, the front end 202 and middle layers 204 may distribute the requests evenly in quantity based on cache slot primary-secondary affinity, write type, allocation type or the like. From the middle layer 204, requests are sent to the back end 206 (BE1-BE4), typically favoring the same node to which the request was received. In such systems there is no active monitoring or feedback mechanism to adjust the distribution at run time.

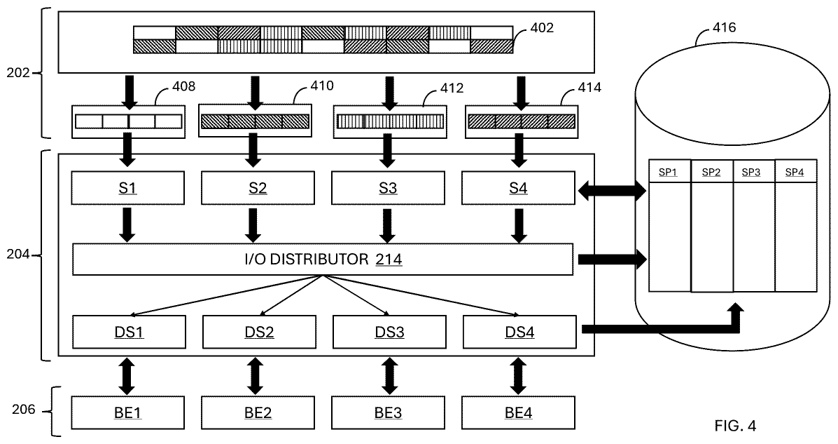

Turning now to FIG. 4, a flow diagram of an I/O request distribution according to aspects of the present disclosure is shown. Incoming requests to a plurality of front end devices 402 may be received by the front end 202 and sent to the middle layer based on or associated with a device group, such as device groups 408-414. In the example of FIG. 4, four device groups 408-414 may each be assigned a specific group of devices, 402. All I/O requests related to that group (e.g., requests received by the front end devices assigned to the group) may be sent to the same idle layer 204. Further, all I/O requests may be distributed by a per-node scheduler (S1-S4, respectively). According to one aspect, front end nodes may be grouped according to existing device configurations, such as a storage group, or according to mathematical rules, or dynamically grouped based on I/O statistics.

On each middle layer node, the per-node scheduler (S1-S4) may be responsible for monitoring workload and system wide statistics in order to distribute the requests to the best middle layer node in the system for destaging. According to one aspect, the scheduler (S1-S4) may identify and select the best middle layer candidate to process requests using a weighted score factoring in one or more statistics relating to the operations of the middle layers 204 and back ends 206 in the system. For example, and without limitation, statistics may include pending I/O count (e.g., in b-tree commit, pending and processing lists), current queue depth of back end writes (including logical and physical queue depths), back end response time, CPU utilization statistics of middle layer and back end processors, current system write pending levels, and cache write pending slot board affinity.

According to one aspect, the statistics consulted by the schedulers S1-S4, may be stored in global memory in a database 416. The database 416 may periodically record and maintain statistics on a system level as well as on a per-node (e.g., storage processor) basis, represented by the tables SP1-SP4 in database 416. Each middle layer may maintain a local copy of the database for performance and efficiency reasons, where the local copies may be updated periodically with updated statistics.

The statistics used by the schedulers S1-S4 may be two-dimensional stats (n×m) collected from all middle layers and back ends, with n parameters per node for m nodes. According to one aspect, the I/O distributor 214 and scheduler S1-S4 may use a weighted score model to determine the optimal destination for a given request from the two-dimensional data stored in the database 216. For example, for each node, a weighted score may determine the node with the maximum score and selected as the destination node for a request. According to one aspect, the score may be found according to:

$${max}_{i} f [ i ] = {\sum }_{j = 0}^{n} ( {w}_{j} {x}_{ij} ) ;$$

where n is the number of nodes, x is a statistical parameter, and w is a given weight.

Alternatively, the optimal destination node may be determined using machine learning techniques. According to one aspect, a machine learning (ML) model may be trained to predict a destination node using a modeling dataset comprising a plurality of training samples. Each training sample may be generated from a corpus of historical I/O requests distributions and statistics. Each training sample of the plurality of training samples may be used to adjust weights in the machine learning model. Training the machine learning model may further include inputting different portions of the training dataset and comparing predictions of customer actions with target values of the training samples to adjust weights in the machine learning network. I/O request data may be used to generate a feature vector representing the request information. The feature vector may be input into the ML model to predict a suitable destination for a request. According to one aspect, the database 216 may be configured according to a time series such that a prediction may reference a change in system dynamics.

According to one aspect, the scheduler S1-S4 may leverage the centralized device management based on the device groups to help in dispatching I/O requests in bulk quantities to provide further optimization. One such case may include front-end track device extent-based grouping for unallocated/uncompressed writes. Since all data tracks in a device group may be managed by one dedicated middle layer scheduler S1-S4, front-end fragmentation may be avoided or reduced by distributing I/O operations belonging to the same extent to a single middle layer node, resulting in front-end-extent based back-end binding. Another case may include back-end SSL masking-based grouping for uncompressed update writes. A front-end device group managed by one dedicated scheduler maximizes back-end SSL write pending track collection for higher probability of optimized write by distributing I/O requests of the same back-end SSL to the same middle layer node.

Accordingly, the I/O distributor may direct I/O requests according to the techniques described above to the various middle layer nodes for destaging processing (DS1-DS4) where the requests are then processed to the nodes BE1-BE4 of the back end 206.

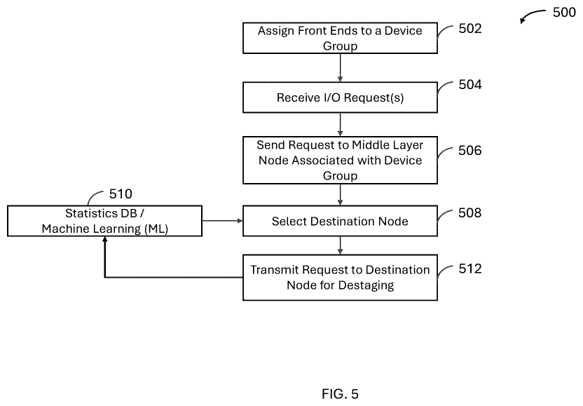

Turning now to FIG. 5, a flow diagram of a method 500 is provided. According to one aspect, as described herein, the front end nodes of a storage array cluster or configuration may be assigned to a device group, shown in block 502. As described above, the assignment of front end nodes to a group may be according to an existing device configuration, mathematical rules, or dynamically grouped based on I/O statistics. As shown in block 504, the front end node may receive an I/O request from a host device. The request may be sent to a middle layer node associated with the device group, as shown in block 506. According to one aspect, a per-node scheduler at the middle layer may select a destination node for the request, shown in block 508.

According to one aspect, the middle node may include, or have access to a database storing I/O statistics of the storage array, shown in block 510. The statistics may be or include system level and device level statistics related to the I/O operations of the array. According to one aspect, the per-node scheduler may determine an optimal destination for the request using one or more of a current pending I/O count, a current queue depth of back end write queues, including logical and physical queue depth, back end response time feedback, CPU utilization statistics of the back ends and middle layers, current system write pending level and cache write pending slot processor affinity. The database may also include or be a machine learning model trained to predict the destination node based on a corpus of historical data I/O request processing data.

Once the per-node scheduler has identified an appropriate candidate for sending the request, the request may be transmitted to the destination node for destaging, shown in block 512. According to one aspect, the statistics database and/or machine learning model may be updated periodically with new or additional statistics as the system continues to operate. Accordingly, the method 500 provides continuous and real-time feedback to the per-node scheduler for improved monitoring and maintaining node equality across the nodes of the array.

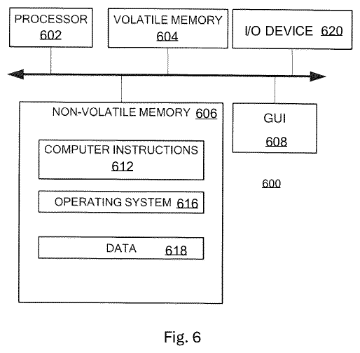

Referring to FIG. 6, in some embodiments, a computing device 600 may include processor 602, volatile memory 604 (e.g., RAM), non-volatile memory 606 (e.g., a hard disk drive, a solid-state drive such as a flash drive, a hybrid magnetic and solid-state drive, etc.), graphical user interface (GUI) 608 (e.g., a touchscreen, a display, and so forth) and input/output (I/O) device 620 (e.g., a mouse, a keyboard, etc.). Non-volatile memory 806 stores computer instructions 612, an operating system 616 and data 618 such that, for example, the computer instructions 612 are executed by the processor 602 out of volatile memory 604. Program code may be applied to data entered using an input device of GUI 608 or received from I/O device 620.

FIGS. 1-6 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-6 may be performed in parallel, in a different order, or altogether omitted.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
assigning each of a plurality of front end nodes in a storage array to a device group;
receiving at a first front end node an input/output (I/O) request;
sending the I/O request to a middle layer node associated with the device group;
selecting by a per-node scheduler a destination node to process the request, the destination node selected according to one or more I/O statistics relating to the storage array; and
transmitting the I/O request to the destination node for destaging.

2. The method of claim 1 wherein selecting a destination node is based on balancing storage array resources.

3. The method of claim 1 wherein the I/O statistics are stored in a database accessible to all nodes of the storage array.

4. The method of claim 3 wherein the database is copied to a global memory in communication with the middle layer.

5. The method of claim 3 wherein the middle layer is configured to update the database periodically.

6. The method of claim 1 wherein the I/O statistics include one or more of a pending I/O count, queue depth, back end response time, CPU utilization, and write pending level.

7. The method of claim 1 wherein selecting a destination node includes using a weighted model.

8. The method of claim 1 wherein selecting a destination node includes using a machine learning model.

9. A system comprising:
a memory; and
at least one processor that is operatively coupled to the memory, the at least one processor being configured to perform the operations of:
assigning each of a plurality of front end nodes in a storage array to a device group;
receiving at a first front end node an input/output (I/O) request;
sending the I/O request to a middle layer node associated with the device group;
selecting by a per-node scheduler a destination node to process the request, the destination node selected according to one or more I/O statistics relating to the storage array; and
transmitting the I/O request to the destination node for destaging.

10. The system of claim 9 wherein selecting a destination node is based on balancing storage array resources.

11. The system of claim 9 wherein the I/O statistics are stored in a database accessible to all nodes of the storage array.

12. The system of claim 11 wherein the database is copied to a global memory in communication with the middle layer.

13. The system of claim 11 wherein the middle layer is configured to update the database periodically.

14. The system of claim 9 wherein the I/O statistics include one or more of a pending I/O count, queue depth, back end response time, CPU utilization, and write pending level.

15. The system of claim 9 wherein selecting a destination node includes using one of a weighted model and a machine learning model.

16. A non-transitory computer-readable medium storing one or more processor-executable instructions, which when executed by at least one processor cause the at least one processor to perform the operations of:
assigning each of a plurality of front end nodes in a storage array to a device group;
receiving at a first front end node an input/output (I/O) request;
sending the I/O request to a middle layer node associated with the device group;
selecting by a per-node scheduler a destination node to process the request, the destination node selected according to one or more I/O statistics relating to the storage array; and
transmitting the I/O request to the destination node for destaging.

17. The non-transitory computer-readable medium of claim 16 wherein the I/O statistics are stored in a database accessible to all nodes of the storage array.

18. The non-transitory computer-readable medium of claim 17 wherein the middle layer is configured to update the database periodically.

19. The non-transitory computer-readable medium of claim 16 wherein the I/O statistics include one or more of a pending I/O count, queue depth, back end response time, CPU utilization, and write pending level.

20. The non-transitory computer-readable medium of claim 16 wherein selecting a destination node includes using one of a weighted model and a machine learning model.
